(19) United States
(12) Patent Application Publication
(10) Pub. No.: US 2002/0051542 A1
(43) Pub. Date: May 2, 2002

(54) PARALLEL SCRAMBLER OF EXCHANGE IN ASYNCHRONOUS TRANSFER MODE

(76) Inventor: JAE-HYEONG KIM, KWANGZU-SI (KR)

Correspondence Address: JAMES S. PARKER, 2421 N.W. 41ST STREET, SUITE A-1, GAINESVILLE, FL, 32606-6669, US

(21) Appl. No.: 09/063,087

(22) Filed: Apr. 20, 1998

(30) Foreign Application Priority Data
Jun. 24, 1997 (KR) 97-26925

(51) Int. Cl. H04L 9/00; H04J 3/00

(52) U.S. Cl. 380/268; 370/521

(57) ABSTRACT

A parallel scrambler of an ATM exchange for mapping ATM cells to STM frames and transmitting data includes: a parallel pseudo-random binary sequence (PRBS) generator for selectively performing a logic operation with respect to two or more PRBSs which are shifted in parallel after being generated for scrambling of the ATM cells and outputting parallel PRBSs in synchronization with an input clock after latching a result of the operation; and a data scrambler for scrambling the parallel PRBSs generated by the parallel PRBS generator and data to be transmitted and latching and outputting scrambled dat.

### BACKGROUND OF THE INVENTION

1. Field of the Invention

The present invention relates to a frame scrambler which is used when an exchange in an asynchronous transfer mode (ATM) maps ATM cells to synchronous transfer mode (STM) frames before transmission. Particularly, this invention relates to a parallel scrambler for lowering an operation speed when scrambling the ATM cells before mapping them to the frames over an STM-1 (155 Mbps) rate by scrambling the data in parallel in an ATM exchange, thereby saving electric power and improving reliability in data scrambling.

2. Discussion of Related Art

In general, when mapping ATM cells to STM frames before transmitting data, the ATM cells are scrambled using a pseudo-random binary sequence (PRBS) formed based on a generator polynomial, X⁷+X⁶+1. FIG. 1 shows a conventional serial scrambler of an ATM exchange used when mapping the ATM cells to the STM frames and transmitting the data through such method.

As shown in FIG. 1, the conventional serial scrambler includes: a PRBS generator 10 having a number of shift registers SR1 to SR7 for shifting input signals at predetermined periods and an exclusive OR element for performing an exclusive OR operation with respect to each data from the sixth and seventh shift registers SR6 and SR7 and sending a result of the operation to the input port of the first shift register SR1; and an exclusive OR element 20 for performing the exclusive OR operation with respect to the PRBS which is generated through shifting by the PRBS generator 10 and data to be transmitted (data in) and outputting scrambled data as a result of the operation.

For such conventional serial scrambler, the PRBS generator 10 generates the PRBS using the generator polynomial, X⁷+X⁶+1, in such a manner of initially setting values of the first to seventh shift registers SR1 to SR7 to “1” using a set signal and outputting one bit of PRBS each time when a clock is generated.

When transmitting ATM cells based upon a synchronous digital hierarchy (SDH), the cells are scrambled just before being transmitted to the STM frames. So, as illustrated above, the exclusive OR operation with respect to the PRBS generated by the PRBS generator 10 and the data to be transmitted (data in) is performed by the exclusive OR element 20. The scrambled data which is the result of the operation is then transmitted to an STM framer.

When scrambling of the ATM cells before mapping them to STM-4 frames is performed by such serial scrambler, data must be inputted to the scrambler at 622.08 Mbps, so the PRBS generator 10 also must operate at the same speed. This is not good for embodiment of an electronic circuit and, moreover, integration of circuits. In other words, the circuit must be embodied using devices available for processing high speed signals, which is not economical and results in an increment of power consumption. This conventional serial scrambler which processes signals at the high speed has other drawbacks such as low reliability and low degree of circuit integration.

### SUMMARY OF THE INVENTION

Accordingly, the present invention is directed to a parallel scrambler of an ATM exchange that substantially obviates one or more of the limitations and disadvantages of the related art.

An object of the present invention is to provide a parallel scrambler for lowering an operation speed when scrambling ATM cells for frames over an STM-1 (155 Mbps) rate by scrambling the data in parallel in an ATM exchange, thereby saving electric power and improving reliability in data scrambling.

Additional features and advantages of the invention will be set forth in the description which follows, and in part will be apparent from the description, or may be learned by practice of the invention. The objectives and other advantages of the invention will be realized and attained by the structure as illustrated in the written description and claims hereof, as well as the appended drawings.

To achieve these and other advantages, and in accordance with the purpose of the present invention as embodied and broadly described, a parallel scrambler of an ATM exchange for mapping ATM cells to STM frames and transmitting data includes: a parallel pseudo-random binary sequence (PRBS) generator for selectively performing a logic operation with respect to two or more PRBSs which are shifted in parallel after being generated for scrambling of the ATM cells and outputting parallel PRBSs in synchronization with an input clock after latching a result of the operation; and a data scrambler for scrambling the parallel PRBSs generated by the parallel PRBS generator and data to be transmitted and latching and outputting scrambled data.

In case of transmitting the data at an STM-1 rate of 155 Mbps, the parallel PRBS generator includes: a PRBS logic unit for selecting two or more PRBSs among the parallel PRBSs which are previously generated for scrambling of the ATM cells and performing the exclusive OR operation with respect to the selected ones; a latch unit for latching the signals from the PRBS logic unit in synchronization with an input clock and generating parallel PRBSs; and an exclusive OR element for performing the exclusive OR operation with respect to first PRBS and second PRBS outputted from the latch unit to generate an eighth PRBS.

In case of transmitting data at an STM-1 rate of 155 Mbps, the data scrambler includes: an AND element for performing an AND operation with respect to a number of PRBSs generated by the parallel PRBS generator and an enable signal which is generated not to scramble frame alignment bytes; an exclusive OR element for performing an exclusive OR operation with respect to an output signal of the AND element and data to be transmitted; and a flip-flop for latching an output signal of the exclusive OR element according to the clock and outputting scrambled data.

In case of transmitting data at an STM-4 rate of 622 Mbps, the parallel PRBS generator includes: a PRBS logic unit for selecting two or more PRBSs among the parallel PRBSs which are previously generated for scrambling of the ATM cells and performing an exclusive OR operation with respect to the selected ones; a latch unit for latching a number of output signals of the PRBS logic unit in synchronization with an input clock and generating parallel PRBSs; and a logic unit for performing the exclusive OR operation with respect to two or more of output signals of the latch unit and outputting eighth to sixteenth PRBSs.

In case of transmitting data at an STM-4 rate of 622 Mbps, the data scrambler includes: an AND element for performing an AND operation with respect to a number of PRBSs from the parallel PRBS generator and an enable signal which is obtained not to scramble frame alignment bytes; an exclusive OR element for performing an exclusive OR operation with respect to an output signal of the AND element and data to be transmitted; and a flip-flop for latching an output signal of the exclusive OR element according to the clock and outputting scrambled data.

It is to be understood that both the foregoing general description and the following detailed description are exemplary and explanatory and are intended to provide further explanation of the invention as claimed.

### BRIEF DESCRIPTION OF THE ATTACHED DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram of a conventional serial scrambler of an ATM exchange;

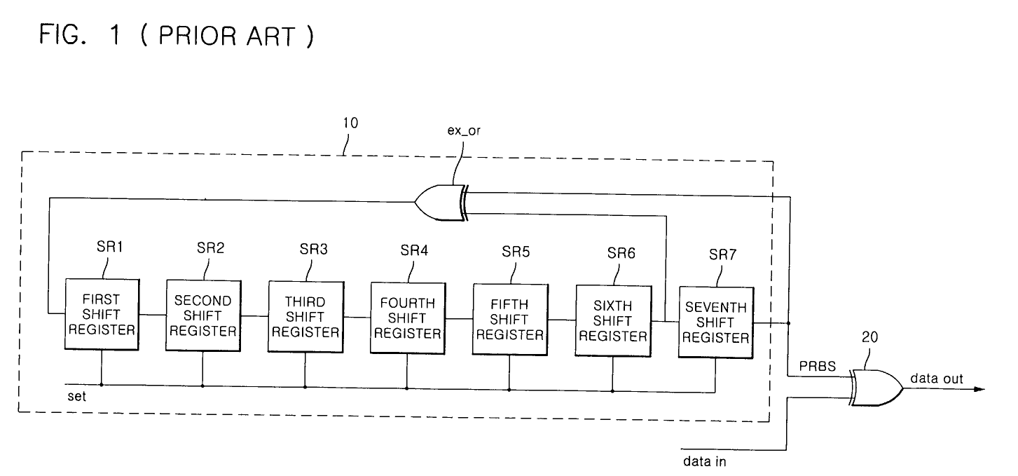

FIG. 2 is a block diagram of a parallel scrambler of an ATM exchange according to the present invention;

FIG. 3 shows a configuration of a parallel scrambler when data of 155 Mbps, an STM-1 rate, is transmitted in the present invention; and

FIG. 4 shows a configuration of a parallel scrambler when data of 622 Mbps, an STM-4 rate, is transmitted in the present invention.

### DETAILED DESCRIPTION OF PREFERRED EMBODIMENT

Reference will now be made in detail to the preferred embodiments of the present invention, examples of which are illustrated in the accompanying drawings.

With reference to the attached drawings, a preferred embodiment of the present invention is described in detail below.

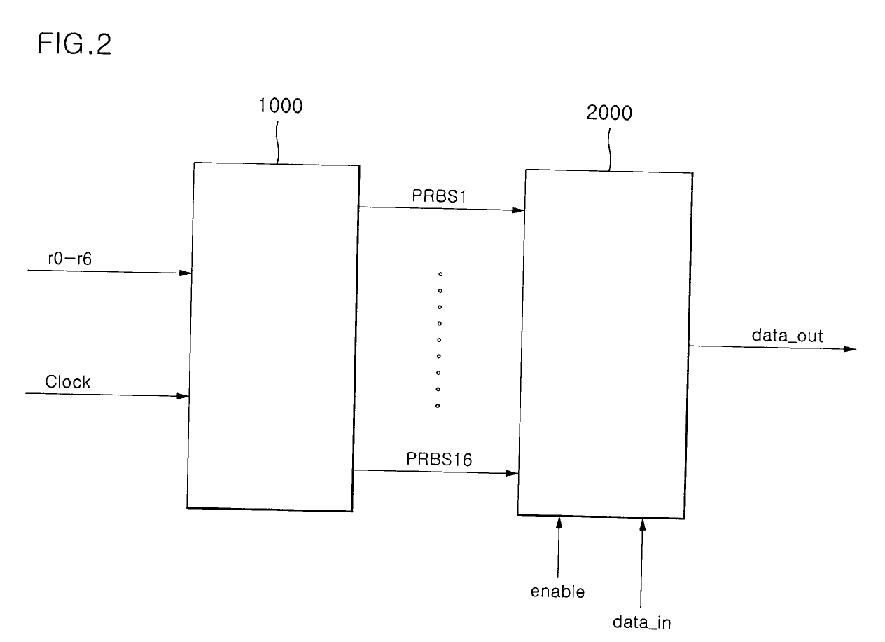

As shown in FIG. 2, the parallel scrambler of an ATM exchange according to the present invention includes: a parallel PRBS generator 1000 for selecting and performing a logic operation with respect to two or more PRBSs (r0-r6) which are shifted in parallel after being generated for scrambling of ATM cells and outputting parallel PRBSs in synchronization with an input clock after latching results of the operation; and a data scrambling unit 2000 for scrambling the parallel PRBSs generated by the parallel PRBS generator 1000 and data to be transmitted and latching and outputting scrambled data.

Specifically, the parallel PRBS generator 1000 selectively mixes the PRBSs (r0-r6) which are generated for mapping ATM cells to STM frames and generates the parallel PRBSs. The data scrambling unit 2000 then scrambles the ATM cell data using the parallel PRBSs generated by the parallel PRBS generator 1000.

This parallel scrambler of the present invention has different configuration according to classes of the STM rate. This is specifically described below.

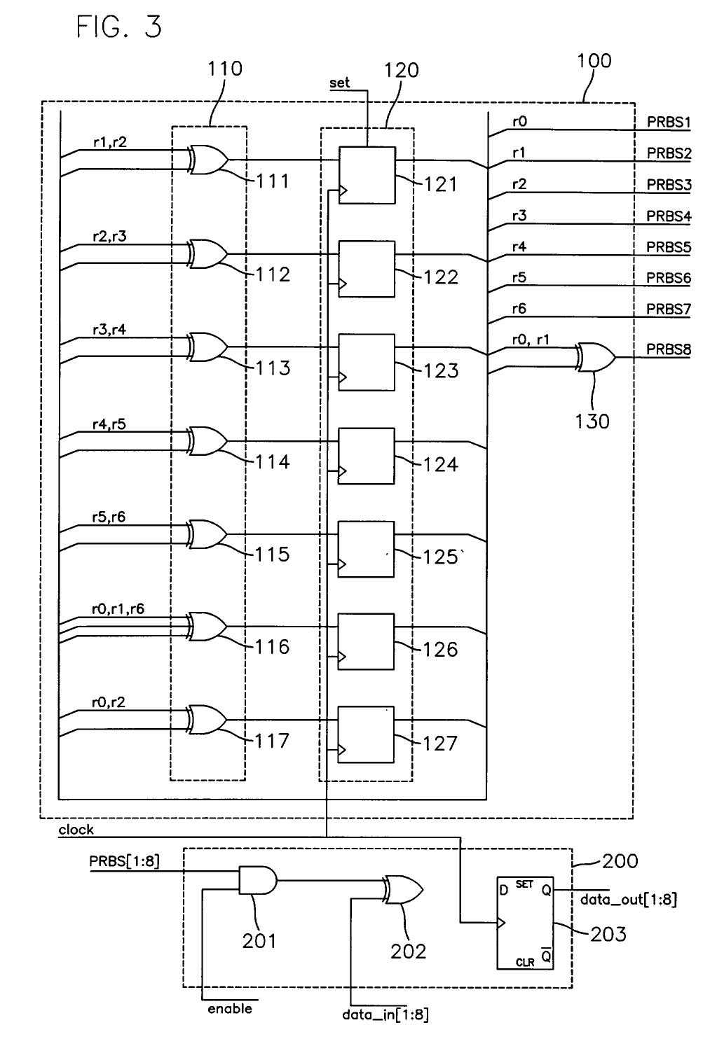

FIG. 3 shows a configuration of a parallel scrambler when data of 155 Mbps, an STM-1 rate, is transmitted in the present invention. As show in FIG. 3, the parallel scrambler includes: a parallel PRBS generator 100 for selectively performing a logic operation with respect to two or more PRBSs (r0-r6) which are shifted in parallel and shifting a result of the operation in synchronization with an input clock so as to generate the parallel PRBSs (PRBS1-PRBS8); and a data scrambling unit 200 for scrambling the parallel PRBSs (PRBS1-PRBS8) generated by the parallel PRBS generator 100 and data to be transmitted (data_in[1:8]) and outputting scrambled data after latching a scrambled result.

The parallel PRBS generator 100 includes: a PRBS logic unit 110 for selecting two or more PRBSs among the seven PRBSs (r0-r6) which are previously generated for the ATM cell scrambling and performing the exclusive OR operation with respect to the selected ones; a latch unit 120 for latching the signals from the PRBS logic unit 110 in synchronization with an input clock and generating the parallel PRBSs (PRBS1-PRBS7); and an exclusive OR element 130 for performing the exclusive OR operation with respect to the first PRBS and second PRBS to generate an eighth PRBS.

The PRBS logic unit 110 has first to seventh exclusive OR elements 111 to 117 for selectively performing the exclusive OR operation with respect to two or more of the seven PRBSs (r0-r6).

The latch unit 120 has first through seventh flip-flops 121 to 127 for latching the signals from the first to seventh OR elements 111 to 117 in synchronization with the input clock and generating the first to seventh PRBSs.

The data scrambling unit 200 includes: an AND element 201 for performing an AND operation with respect to the first to eighth PRBSs (PRBS1-PRBS8) and an enable signal obtained not to scramble frame alignment bytes; an exclusive OR element 202 for performing the exclusive OR operation with respect to the output signal of the AND element 201 and the data to be transmitted (data_in[1:8]); and a flip-flop 203 for latching the output signal of the exclusive OR element 202 according to the clock and outputting the scrambled data (data_out[1:8]).

For the parallel scrambler having such configuration, eight PRBSs should be generated at one clock to scramble the data in parallel by 8 bits. The PRBS absolutely depends on the previous status of a register, so data generated from the first clock until the eighth clock and the register's status after the eighth clock is generated can be assumed. This is embodied in the parallel PRBS generator 100 depicted in FIG. 3. Each exclusive OR element 111 to 117 in the PRBS logic unit 110 performs the exclusive OR operation with respect to two or more PRBSs (r0-r6) which have been previously generated for the ATM cell scrambling and transmits the operated results to the latch unit 120. The latch unit 120 sequentially shifts the signals from each OR element by one bit in synchronization with the input clock so as to output first to seventh PRBSs (PRBS1-PRBS7). The exclusive OR element 130 performs the exclusive OR operation with respect to the first and second PRBSs respectively generated by the first and second flip-flops 121 and 122 to generate the eighth PRBS.

More specifically, when t=T (T is a period of time of a clock), the status of each register and an output PRBS after one clock is inputted appears as follows.

The value of the second flip-flop 122, r1, is inputted to the first flip-flop 121; r2, to the second flip-flop 122; r3, to the third flip-flop 123; r4, to the fourth flip-flop 124; r5, to the fifth flip-flop 125; r6, to the sixth flip-flop 126; and a result of the exclusive OR operation of the r1 and r0, to the seventh flip-flop 127. The output PRBS is a value generated by the first flip-flop 121.

The above co-relation can be expressed as the formula,

r0(T)=r1(0)

r1(T)=r2(0)

r2(T)=r3(0)

r3(T)=r4(0)

r4(T)=r5(0)

r5(T)=r6(0)

r6(T)=r0(0)⊕r1(0)

Output PRBS=r0(0).

Since the above co-relation is repeated every clock, for the convenience of calculation, the above formula can be expressed as a vector as follows.

$$R ( T ) = A \cdot R ( 0 ) \cdot A = \vert \begin{matrix}0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 1 & 1 & 0 & 0 & 0 & 0 & 0\end{matrix} \vert R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( T ) = \vert \begin{matrix}r0 ( T ) \\ r1 ( T ) \\ r2 ( T ) \\ r3 ( T ) \\ r4 ( T ) \\ r5 ( T ) \\ r6 ( T )\end{matrix} \vert$$

When calculating the output PRBS until t=8T (8 clocks) according to the above principle, the result is as follows. For example,

when t=2T,

$$R ( 2 T ) = {A}^{2} \cdot R ( 0 )$$

$${A}^{2} = \vert \begin{matrix}0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 1 & 1 & 0 & 0 & 0 & 0 & 0 \\ 0 & 1 & 1 & 0 & 0 & 0 & 0\end{matrix} \vert R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 2 T ) = \vert \begin{matrix}r0 ( 2 T ) \\ r1 ( 2 T ) \\ r2 ( 2 T ) \\ r3 ( 2 T ) \\ r4 ( 2 T ) \\ r5 ( 2 T ) \\ r6 ( 2 T )\end{matrix} \vert \\ O u t p u t P R B S = r0 ( T ) = r1 ( 0 ) .$$

when t=3T,

$$R ( 3 T ) = {A}^{3} \cdot R ( 0 )$$

$${A}^{3} = \vert \begin{matrix}0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 1 & 1 & 0 & 0 & 0 & 0 & 0 \\ 0 & 1 & 1 & 0 & 0 & 0 & 1 \\ 0 & 0 & 1 & 1 & 0 & 0 & 0\end{matrix} \vert R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 3 T ) = \vert \begin{matrix}r0 ( 3 T ) \\ r1 ( 3 T ) \\ r2 ( 3 T ) \\ r3 ( 3 T ) \\ r4 ( 3 T ) \\ r5 ( 3 T ) \\ r6 ( 3 T )\end{matrix} \vert \\ O u t p u t P R B S = r0 ( 2 T ) = r2 ( 0 ) .$$

when t=4T,

$$R ( 4 T ) = {A}^{4} \cdot R ( 0 )$$

$${A}^{4} = \vert \begin{matrix}0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 1 & 1 & 0 & 0 & 0 & 0 & 0 \\ 0 & 1 & 1 & 0 & 0 & 0 & 0 \\ 0 & 0 & 1 & 1 & 0 & 0 & 0 \\ 0 & 0 & 0 & 1 & 1 & 0 & 0\end{matrix} \vert R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 4 T ) = \vert \begin{matrix}r0 ( 4 T ) \\ r1 ( 4 T ) \\ r2 ( 4 T ) \\ r3 ( 4 T ) \\ r4 ( 4 T ) \\ r5 ( 4 T ) \\ r6 ( 4 T )\end{matrix} \vert \\ O u t p u t P R B S = r0 ( 3 T ) = r3 ( 0 ) .$$

when t=5T,

$$R ( 5 T ) = {A}^{5} \cdot R ( 0 )$$

$${A}^{5} = \vert \begin{matrix}0 & 0 & 0 & 0 & 0 & 1 & 0 \\ 0 & 0 & 0 & 0 & 0 & 0 & 1 \\ 1 & 1 & 0 & 0 & 0 & 0 & 0 \\ 0 & 1 & 1 & 0 & 0 & 0 & 0 \\ 0 & 0 & 1 & 1 & 0 & 0 & 0 \\ 0 & 0 & 0 & 1 & 1 & 0 & 0 \\ 0 & 0 & 0 & 0 & 1 & 1 & 0\end{matrix} \vert R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 5 T ) = \vert \begin{matrix}r0 ( 5 T ) \\ r1 ( 5 T ) \\ r2 ( 5 T ) \\ r3 ( 5 T ) \\ r4 ( 5 T ) \\ r5 ( 5 T ) \\ r6 ( 5 T )\end{matrix} \vert \\ O u t p u t P R B S = r0 ( 4 T ) = r4 ( 0 ) .$$

when t=6T,

$$R ( 6 T ) = {A}^{6} \cdot R ( 0 )$$

$${A}^{6} = \vert \begin{matrix}0 & 0 & 0 & 0 & 0 & 0 & 1 \\ 1 & 1 & 0 & 0 & 0 & 0 & 0 \\ 0 & 1 & 1 & 0 & 0 & 0 & 0 \\ 0 & 0 & 1 & 1 & 0 & 0 & 0 \\ 0 & 0 & 0 & 1 & 1 & 0 & 0 \\ 0 & 0 & 0 & 0 & 1 & 1 & 0 \\ 0 & 0 & 0 & 0 & 0 & 1 & 1\end{matrix} \vert R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 6 T ) = \vert \begin{matrix}r0 ( 6 T ) \\ r1 ( 6 T ) \\ r2 ( 6 T ) \\ r3 ( 6 T ) \\ r4 ( 6 T ) \\ r5 ( 6 T ) \\ r6 ( 6 T )\end{matrix} \vert \\ O u t p u t P R B S = r0 ( 5 T ) = r5 ( 0 ) .$$

when t=7T,

$$R ( 7 T ) = {A}^{7} \cdot R ( 0 )$$

$${A}^{6} = \vert \begin{matrix}1 & 1 & 0 & 0 & 0 & 0 & 0 \\ 0 & 1 & 1 & 0 & 0 & 0 & 0 \\ 0 & 0 & 1 & 1 & 0 & 0 & 0 \\ 0 & 0 & 0 & 1 & 1 & 0 & 0 \\ 0 & 0 & 0 & 0 & 1 & 1 & 0 \\ 0 & 0 & 0 & 0 & 0 & 1 & 1 \\ 1 & 1 & 0 & 0 & 0 & 0 & 1\end{matrix} \vert R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 7 T ) = \vert \begin{matrix}r0 ( 7 T ) \\ r1 ( 7 T ) \\ r2 ( 7 T ) \\ r3 ( 7 T ) \\ r4 ( 7 T ) \\ r5 ( 7 T ) \\ r6 ( 7 T )\end{matrix} \vert \\ O u t p u t P R B S = r0 ( 6 T ) = r6 ( 0 ) .$$

when t=8T,

$$R ( 8 T ) = {A}^{8} \cdot R ( 0 )$$

$${A}^{6} = \vert \begin{matrix}0 & 1 & 1 & 0 & 0 & 0 & 0 \\ 0 & 0 & 1 & 1 & 0 & 0 & 0 \\ 0 & 0 & 0 & 1 & 1 & 0 & 0 \\ 0 & 0 & 0 & 0 & 1 & 1 & 0 \\ 0 & 0 & 0 & 0 & 0 & 1 & 1 \\ 1 & 1 & 0 & 0 & 0 & 0 & 1 \\ 1 & 0 & 1 & 0 & 0 & 0 & 0\end{matrix} \vert R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 8 T ) = \vert \begin{matrix}r0 ( 8 T ) \\ r1 ( 8 T ) \\ r2 ( 8 T ) \\ r3 ( 8 T ) \\ r4 ( 8 T ) \\ r5 ( 8 T ) \\ r6 ( 8 T )\end{matrix} \vert \\ O u t p u t P R B S : r0 ( 7 T ) = r0 ( 0 ) ⊕ r1 ( 0 ) .$$

To satisfy the above conditions, all the flip-flops 121 to 127 are initially set to “1” using a set terminal and made to generate eight PRBSs after one clock. Since the operating clock transmitted to each flip-flop 121 to 127 is processed in parallel by 8 bits, in case of an STM-1 (155.52 Mbps) rate, a clock of 19.44 MHz is inputted. The AND element 201 in the data scrambling unit 200 performs the AND operation with respect to the 8 bits parallel PRBS (PRBS1-PRBS8) and the enable signal and applies an operated result to an input port of the exclusive OR element 202. Performing the AND operation of the 8 bins parallel PRBS and enable signal is for preventing scrambling of the frame alignment bytes in the STM frames.

The exclusive OR element 202 performs the exclusive OR operation with respect to the output signal of the AND element 201 and the 8-bit data to be transmitted (data_in[1:8]) in order to scramble the data. The flip-flop 203 latches the scrambled data in synchronization with the clock and sends the transmission data to the STM framer, so the data is formatted as the STM frame.

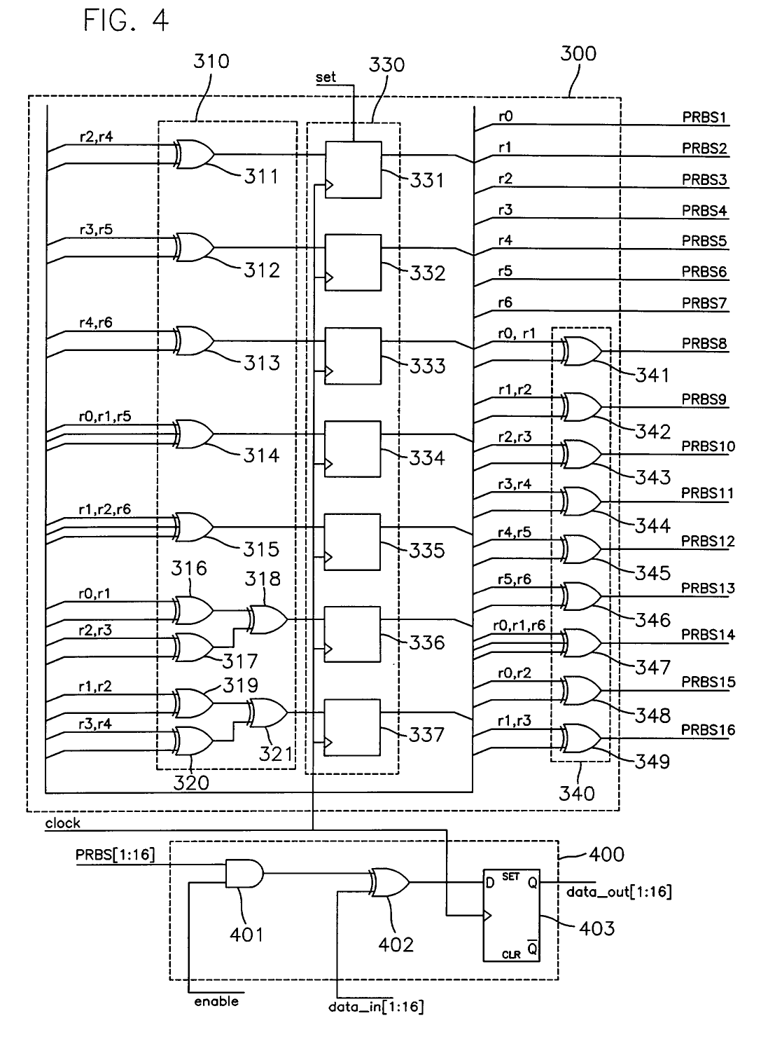

FIG. 4 shows a configuration of a parallel scrambler when data of 622 Mbps, an STM-4 rate, is transmitted in the present invention.

This is a 16-bit parallel scrambler which includes: a parallel PRBS generator 300 for selecting and performing a logic operation with respect to two or more PRBSs (r0-r6) which are shifted in parallel and shifting a result of the operation in synchronization with an input clock so as to generate parallel PRBSs (PRBS1-PRBS16); and a data scrambling unit 400 for scrambling the parallel PRBSs (PRBS1-PRBS16) generated by the parallel PRBS generator 300 and data to be transmitted and outputting scrambled data after latching a scrambled result.

The parallel PRBS generator 300 includes: a PRBS logic unit 310 for selecting two or more PRBSs among the seven PRBSs (r0-r6) and performing an exclusive OR operation with respect to the selected ones; a latch unit 330 for latching the signals from the PRBS logic unit 310 in synchronization with the input clock and generating the parallel PRBS (PRBS1-PRBS7); and a logic unit 340 for performing the exclusive OR operation with respect to two or more output signals (r0-r6) of the latch unit 330 to generate the eighth through sixteenth PRBSs.

The PRBS logic unit 310 has first to eleventh exclusive OR elements 311 to 321 for selectively performing the exclusive OR operation with respect to two or more of the seven PRBSs (r0-r6) The latch unit 330 has first through seventh flip-flops 331 to 337 for latching the signals from the first to eleventh OR elements 311 to 321 in synchronization with the input clock and generating the first to seventh PRBSs.

The logic unit 340 has a number of exclusive OR elements 341 to 349 for selectively performing the exclusive OR operation with respect to the two or more output signals (r0-r6) of the flip-flops 331 to 337 and outputting operated results as the eighth to sixteenth PRBSs.

The data scrambling unit 400 includes: an AND element 401 for performing an AND operation with respect to the first to sixteenth PRBSs (PRBS1-PRBS16) and an enable signal which is obtained not to scramble frame alignment bytes; an exclusive OR element 402 for performing the exclusive OR operation with respect to the output signal of the AND element 401 and the data to be transmitted (data_in[1:16]); and a flip-flop 403 for latching the output signal of the exclusive OR element 402 according to the clock and outputting scrambled data (data_out[1:16]).

For this parallel scrambler having such configuration, 16 PRBSs should be generated at one clock to scramble the data in parallel by 16 bits. The PRBS absolutely depends on the previous status of a register, so data generated from the first clock until the 16th clock and the register's status after the 16th clock is generated can be assumed.

This is embodied in the parallel PRBS generator 300 depicted in FIG. 4. Each exclusive OR element 311 to 321 in the PRBS logic unit 310 performs the exclusive OR operation with respect to the two or more PRBSs (r0-r6) which have been previously generated and transmits the operated results to the latch unit 330. The latch unit 330 sequentially shifts the signals from each OR element by one bit in synchronization with the input clock and generate the first to seventh PRBSs (PRBS1-PRBS7). The logic unit 340 performs the exclusive OR operation with respect to the first to seventh PRBSs (r0-r6) respectively generated by the first to seventh flip-flops 331 to 337 to generate the eighth to sixteenth PRBSs (PRBS8-PRBS16).

More specifically, when t=T (T is a period of time of a clock), the status of each register and an output PRBS after one clock is inputted appears as follows.

The value of the second flip-flop 332, r1, is inputted to the first flip-flop 331; r2, to the second flip-flop 332; r3, to the third flip-flop 333; r4, to the fourth flip-flop 334; r5, to the fifth flip-flop 335; r6, to the sixth flip-flop 336; and a result of the exclusive OR operation of the r1 and r0, to the seventh flip-flop 337. The output PRBS is a value generated by the first flip-flop 331.

The above co-relation can be expressed as the formula,

r0(T)=r1(0)

r1(T)=r2(0)

r2(T)=r3(0)

r3(T)=r4(0)

r4(T)=r5(0)

r5(T)=r6(0)

r6(T)=r0(0)⊕r1(0)

Output PRBS=r0(0)

Since the above co-relation is repeated every clock, for the convenience of calculation, the above formula can be expressed as a vector as follows.

$$R ( T ) = A \cdot R ( 0 )$$

$$A = \vert \begin{matrix}0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 1 & 1 & 0 & 0 & 0 & 0 & 0\end{matrix} \vert R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( T ) = \vert \begin{matrix}r0 ( T ) \\ r1 ( T ) \\ r2 ( T ) \\ r3 ( T ) \\ r4 ( T ) \\ r5 ( T ) \\ r6 ( T )\end{matrix} \vert$$

When calculating the output PRBS until t=16T (16 clocks) according to the above principle, the result is as follows. For example,

when t=2T,

$$R ( 2 T ) = {A}^{2} \cdot R ( 0 )$$

$${A}^{2} = \vert \begin{matrix}0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 1 & 1 & 0 & 0 & 0 & 0 & 0 \\ 0 & 1 & 1 & 0 & 0 & 0 & 0\end{matrix} \vert R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 2 T ) = \vert \begin{matrix}r0 ( 2 T ) \\ r1 ( 2 T ) \\ r2 ( 2 T ) \\ r3 ( 2 T ) \\ r4 ( 2 T ) \\ r5 ( 2 T ) \\ r6 ( 2 T )\end{matrix} \vert \\ O u t p u t P R B S = r0 ( T ) = r1 ( 0 )$$

when t=3T,

$$R ( 3 T ) = {A}^{j} \cdot R ( 0 )$$

$${A}^{3} = \vert \begin{matrix}0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 1 & 1 & 0 & 0 & 0 & 0 & 0 \\ 0 & 1 & 1 & 0 & 0 & 0 & 1 \\ 0 & 0 & 1 & 1 & 0 & 0 & 0\end{matrix} \vert$$

$$R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 3 T ) = \vert \begin{matrix}r0 ( 3 T ) \\ r1 ( 3 T ) \\ r2 ( 3 T ) \\ r3 ( 3 T ) \\ r4 ( 3 T ) \\ r5 ( 3 T ) \\ r6 ( 3 T )\end{matrix} \vert$$

$$Output PRBS = r0 ( 2 T ) = r2 ( 0 )$$

when t=4T,

$$R ( 4 T ) = {A}^{4} \cdot R ( 0 )$$

$${A}^{4} = \vert \begin{matrix}0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 1 & 1 & 0 & 0 & 0 & 0 & 0 \\ 0 & 1 & 1 & 0 & 0 & 0 & 0 \\ 0 & 0 & 1 & 1 & 0 & 0 & 0 \\ 0 & 0 & 0 & 1 & 1 & 0 & 0\end{matrix} \vert$$

$$R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 4 T ) = \vert \begin{matrix}r0 ( 4 T ) \\ r1 ( 4 T ) \\ r2 ( 4 T ) \\ r3 ( 4 T ) \\ r4 ( 4 T ) \\ r5 ( 4 T ) \\ r6 ( 4 T )\end{matrix} \vert$$

$$Output PRBS = r0 ( 3 T ) = r3 ( 0 )$$

when t=5T,

$$R ( 5 T ) = {A}^{5} \cdot R ( 0 )$$

$${A}^{5} = \vert \begin{matrix}0 & 0 & 0 & 0 & 0 & 1 & 0 \\ 0 & 0 & 0 & 0 & 0 & 0 & 1 \\ 1 & 1 & 0 & 0 & 0 & 0 & 0 \\ 0 & 1 & 1 & 0 & 0 & 0 & 0 \\ 0 & 0 & 1 & 1 & 0 & 0 & 0 \\ 0 & 0 & 0 & 1 & 1 & 0 & 0 \\ 0 & 0 & 0 & 0 & 1 & 1 & 0\end{matrix} \vert$$

$$R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 5 T ) = \vert \begin{matrix}r0 ( 5 T ) \\ r1 ( 5 T ) \\ r2 ( 5 T ) \\ r3 ( 5 T ) \\ r4 ( 5 T ) \\ r5 ( 5 T ) \\ r6 ( 5 T )\end{matrix} \vert$$

$$Output PRBS = r0 ( 4 T ) = r4 ( 0 )$$

when t=6T,

$$R ( 6 T ) = {A}^{6} \cdot R ( 0 )$$

$${A}^{6} = \vert \begin{matrix}0 & 0 & 0 & 0 & 0 & 0 & 1 \\ 1 & 1 & 0 & 0 & 0 & 0 & 0 \\ 0 & 1 & 1 & 0 & 0 & 0 & 0 \\ 0 & 0 & 1 & 1 & 0 & 0 & 0 \\ 0 & 0 & 0 & 1 & 1 & 0 & 0 \\ 0 & 0 & 0 & 0 & 1 & 1 & 0 \\ 0 & 0 & 0 & 0 & 0 & 1 & 1\end{matrix} \vert$$

$$R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 6 T ) = \vert \begin{matrix}r0 ( 6 T ) \\ r1 ( 6 T ) \\ r2 ( 6 T ) \\ r3 ( 6 T ) \\ r4 ( 6 T ) \\ r5 ( 6 T ) \\ r6 ( 6 T )\end{matrix} \vert$$

$$Output PRBS = r0 ( 5 T ) = r5 ( 0 )$$

when t=7T,

$$R ( 7 T ) = {A}^{7} \cdot R ( 0 )$$

$${A}^{7} = \vert \begin{matrix}1 & 1 & 0 & 0 & 0 & 0 & 0 \\ 0 & 1 & 1 & 0 & 0 & 0 & 0 \\ 0 & 0 & 1 & 1 & 0 & 0 & 0 \\ 0 & 0 & 0 & 1 & 1 & 0 & 0 \\ 0 & 0 & 0 & 0 & 1 & 1 & 0 \\ 0 & 0 & 0 & 0 & 0 & 1 & 1 \\ 1 & 1 & 0 & 0 & 0 & 0 & 1\end{matrix} \vert$$

$$R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 7 T ) = \vert \begin{matrix}r0 ( 7 T ) \\ r1 ( 7 T ) \\ r2 ( 7 T ) \\ r3 ( 7 T ) \\ r4 ( 7 T ) \\ r5 ( 7 T ) \\ r6 ( 7 T )\end{matrix} \vert$$

$$Output PRBS = r0 ( 6 T ) = r6 ( 0 )$$

when t=8T,

$$R ( 8 T ) = {A}^{8} \cdot R ( 0 )$$

$${A}^{8} = \vert \begin{matrix}0 & 1 & 1 & 0 & 0 & 0 & 0 \\ 0 & 0 & 1 & 1 & 0 & 0 & 0 \\ 0 & 0 & 0 & 1 & 1 & 0 & 0 \\ 0 & 0 & 0 & 0 & 1 & 1 & 0 \\ 0 & 0 & 0 & 0 & 0 & 1 & 1 \\ 1 & 1 & 0 & 0 & 0 & 0 & 1 \\ 1 & 0 & 1 & 0 & 0 & 0 & 0\end{matrix} \vert$$

$$R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 8 T ) = \vert \begin{matrix}r0 ( 8 T ) \\ r1 ( 8 T ) \\ r2 ( 8 T ) \\ r3 ( 8 T ) \\ r4 ( 8 T ) \\ r5 ( 8 T ) \\ r6 ( 8 T )\end{matrix} \vert$$

$$Output PRBS : r0 ( 7 T ) = r0 ( 0 ) ⊕ r1 ( 0 )$$

when t=9T,

$$R ( 9 T ) = {A}^{9} \cdot R ( 0 )$$

$${A}^{9} = \vert \begin{matrix}0 & 0 & 1 & 1 & 0 & 0 & 0 \\ 0 & 0 & 0 & 1 & 1 & 0 & 0 \\ 0 & 0 & 0 & 0 & 1 & 1 & 0 \\ 0 & 0 & 0 & 0 & 0 & 1 & 1 \\ 1 & 1 & 0 & 0 & 0 & 0 & 1 \\ 1 & 0 & 1 & 0 & 0 & 0 & 0 \\ 0 & 1 & 0 & 1 & 0 & 0 & 0\end{matrix} \vert$$

$$R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 8 T ) = \vert \begin{matrix}r0 ( 9 T ) \\ r1 ( 9 T ) \\ r2 ( 9 T ) \\ r3 ( 9 T ) \\ r4 ( 9 T ) \\ r5 ( 9 T ) \\ r6 ( 9 T )\end{matrix} \vert$$

$$Output PRBS : r0 ( 8 T ) = r1 ( 0 ) ⊕ r2 ( 0 )$$

when t=10T,

$$R ( 10 T ) = {A}^{10} \cdot R ( 0 )$$

$${A}^{10} = \vert \begin{matrix}0 & 0 & 0 & 1 & 1 & 0 & 0 \\ 0 & 0 & 0 & 0 & 1 & 1 & 0 \\ 0 & 0 & 0 & 0 & 0 & 1 & 1 \\ 1 & 1 & 0 & 0 & 0 & 0 & 1 \\ 1 & 0 & 1 & 0 & 0 & 0 & 0 \\ 0 & 1 & 0 & 1 & 0 & 0 & 0 \\ 0 & 0 & 1 & 0 & 1 & 0 & 0\end{matrix} \vert$$

$$R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 10 T ) = \vert \begin{matrix}r0 ( 11 T ) \\ r1 ( 11 T ) \\ r2 ( 11 T ) \\ r3 ( 11 T ) \\ r4 ( 11 T ) \\ r5 ( 11 T ) \\ r6 ( 11 T )\end{matrix} \vert$$

$$Output PRBS : r0 ( 9 T ) = r2 ( 0 ) ⊕ r3 ( 0 )$$

when t=11T,

$$R ( 11 T ) = {A}^{11} \cdot R ( 0 )$$

$${A}^{11} = \vert \begin{matrix}0 & 0 & 0 & 0 & 1 & 1 & 0 \\ 0 & 0 & 0 & 0 & 0 & 1 & 1 \\ 1 & 1 & 0 & 0 & 0 & 0 & 1 \\ 1 & 0 & 1 & 0 & 0 & 0 & 0 \\ 0 & 1 & 0 & 1 & 0 & 0 & 0 \\ 0 & 0 & 1 & 0 & 1 & 0 & 0 \\ 0 & 0 & 0 & 1 & 0 & 1 & 0\end{matrix} \vert$$

$$R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 11 T ) = \vert \begin{matrix}r0 ( 10 T ) \\ r1 ( 10 T ) \\ r2 ( 10 T ) \\ r3 ( 10 T ) \\ r4 ( 10 T ) \\ r5 ( 10 T ) \\ r6 ( 10 T )\end{matrix} \vert$$

$$Output PRBS : r0 ( 10 T ) = r3 ( 0 ) ⊕ r4 ( 0 )$$

when t=12T,

$$R ( 12 T ) = {A}^{12} \cdot R ( 0 )$$

$${A}^{12} = \vert \begin{matrix}0 & 0 & 0 & 0 & 0 & 1 & 1 \\ 1 & 1 & 0 & 0 & 0 & 0 & 1 \\ 1 & 0 & 1 & 0 & 0 & 0 & 0 \\ 0 & 1 & 0 & 1 & 0 & 0 & 0 \\ 0 & 0 & 1 & 0 & 1 & 0 & 0 \\ 0 & 0 & 0 & 1 & 0 & 1 & 0 \\ 0 & 0 & 0 & 0 & 1 & 0 & 1\end{matrix} \vert$$

$$R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 12 T ) = \vert \begin{matrix}r0 ( 12 T ) \\ r1 ( 12 T ) \\ r2 ( 12 T ) \\ r3 ( 12 T ) \\ r4 ( 12 T ) \\ r5 ( 12 T ) \\ r6 ( 12 T )\end{matrix} \vert$$

$$Output PRBS : r0 ( 11 T ) = r4 ( 0 ) ⊕ r5 ( 0 )$$

when t=13T,

$$R ( 13 T ) = {A}^{13} \cdot R ( 0 )$$

$${A}^{13} = \vert \begin{matrix}1 & 1 & 0 & 0 & 0 & 0 & 1 \\ 1 & 0 & 1 & 0 & 0 & 0 & 0 \\ 0 & 1 & 0 & 1 & 0 & 0 & 0 \\ 0 & 0 & 1 & 0 & 1 & 0 & 0 \\ 0 & 0 & 0 & 1 & 0 & 1 & 0 \\ 0 & 0 & 0 & 0 & 1 & 0 & 1 \\ 1 & 1 & 0 & 0 & 0 & 1 & 0\end{matrix} \vert R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 13 T ) = \vert \begin{matrix}r0 ( 13 T ) \\ r1 ( 13 T ) \\ r2 ( 13 T ) \\ r3 ( 13 T ) \\ r4 ( 13 T ) \\ r5 ( 13 T ) \\ r6 ( 13 T )\end{matrix} \vert$$

$$Output PRBS : r0 ( 12 T ) = r5 ( 0 ) ⊕ r6 ( 0 )$$

when t=14T,

$$R ( 14 T ) = {A}^{14} \cdot R ( 0 )$$

$${A}^{14} = \vert \begin{matrix}1 & 0 & 1 & 0 & 0 & 0 & 0 \\ 0 & 1 & 0 & 1 & 0 & 0 & 0 \\ 0 & 0 & 1 & 0 & 1 & 0 & 0 \\ 0 & 0 & 0 & 1 & 0 & 1 & 0 \\ 0 & 0 & 0 & 0 & 1 & 0 & 1 \\ 1 & 1 & 0 & 0 & 0 & 1 & 0 \\ 0 & 1 & 1 & 0 & 0 & 0 & 1\end{matrix} \vert R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 14 T ) = \vert \begin{matrix}r0 ( 14 T ) \\ r1 ( 14 T ) \\ r2 ( 14 T ) \\ r3 ( 14 T ) \\ r4 ( 14 T ) \\ r5 ( 14 T ) \\ r 6 ( 14 T )\end{matrix} \vert$$

$$Output PRBS : r0 ( 13 T ) = r0 ( 0 ) ⊕ r1 ( 0 ) ⊕ r6 ( 0 )$$

when t=15T,

$$R ( 15 T ) = {A}^{15} \cdot R ( 0 )$$

$${A}^{15} = \vert \begin{matrix}0 & 1 & 0 & 1 & 0 & 0 & 0 \\ 0 & 0 & 1 & 0 & 1 & 0 & 0 \\ 0 & 0 & 0 & 1 & 0 & 1 & 0 \\ 0 & 0 & 0 & 0 & 1 & 0 & 1 \\ 1 & 1 & 0 & 0 & 0 & 1 & 0 \\ 0 & 1 & 1 & 0 & 0 & 0 & 1 \\ 1 & 1 & 1 & 1 & 0 & 0 & 0\end{matrix} \vert R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 15 T ) = \vert \begin{matrix}r0 ( 15 T ) \\ r1 ( 15 T ) \\ r2 ( 15 T ) \\ r3 ( 15 T ) \\ r4 ( 15 T ) \\ r5 ( 15 T ) \\ r 6 ( 15 T )\end{matrix} \vert$$

$$output PRBS : r0 ( 14 T ) = r1 ( 0 ) ⊕ r2 ( 0 )$$

when t=16T,

$$R ( 16 T ) = {A}^{16} \cdot R ( 0 )$$

$${A}^{16} = \vert \begin{matrix}0 & 0 & 1 & 0 & 1 & 0 & 0 \\ 0 & 0 & 0 & 1 & 0 & 1 & 0 \\ 0 & 0 & 0 & 0 & 1 & 0 & 1 \\ 1 & 1 & 0 & 0 & 0 & 1 & 0 \\ 0 & 1 & 1 & 0 & 0 & 0 & 1 \\ 1 & 1 & 1 & 1 & 0 & 0 & 0 \\ 0 & 1 & 1 & 1 & 1 & 0 & 0\end{matrix} \vert R ( 0 ) = \vert \begin{matrix}r0 ( 0 ) \\ r1 ( 0 ) \\ r2 ( 0 ) \\ r3 ( 0 ) \\ r4 ( 0 ) \\ r5 ( 0 ) \\ r6 ( 0 )\end{matrix} \vert R ( 16 T ) = \vert \begin{matrix}r0 ( 16 T ) \\ r1 ( 16 T ) \\ r2 ( 16 T ) \\ r3 ( 16 T ) \\ r4 ( 16 T ) \\ r5 ( 16 T ) \\ r 6 ( 16 T )\end{matrix} \vert$$

$$output PRBS : r0 ( 15 T ) = r1 ( 0 ) ⊕ r3 ( 0 ) .$$

To satisfy the above conditions, all the flip-flops 321 to 327 are initially set to “1” using a set terminal and made to generate the 16 PRBSs after one clock. Since the operating clock transmitted to each flip-flop 321 to 327 is processed in parallel by 16 bits, in case of an STM-4 (622.08 Mbps) rate, a clock of 38.88 MHz is inputted. The AND element 401 in the data scrambling unit 400 performs the AND operation with respect to the 16 bits parallel PRBS (PRBS1-PRBS16) and the enable signal and applies an operated result to an input port of the exclusive OR element 402. Performing the AND operation of the 16 bits parallel PRBS and enable signal is for preventing scrambling of the frame alignment bytes in the STM frames.

The exclusive OR element 402 performs the exclusive OR operation with respect to the output signal of the AND element 401 and the 16-bit data to be transmitted (data_in[1:16]) to scramble the data. The flip-flop 403 latches the scrambled data in synchronization with the clock and sends the transmission data to the STM framer, so the data is formatted as the STM frame.

As illustrated above, the present invention processes data in parallel by 8 bits or 16 bits when scrambling the data of an STM-1 rate of 155 Mbps or an STM-4 rate of 622 Mbps, allowing a low speed process (155M/8=19.44M, 622M/16=38.88M), thereby constructing a scrambler with cheaper devices without using expensive devices. In addition, the present invention does not use high speed devices, thereby saving electric power and improving reliability and integration.

It will be apparent to those skilled in the art that various modifications and variations can be made in a parallel scrambler of an ATM exchange of the present invention without deviating from the spirit or scope of the invention. Thus, it is intended that the present invention cover the modifications and variations of this invention provided they come within the scope of the appended claims and their equivalents.

What is claimed is:

1. A parallel scrambler of an ATM exchange for mapping ATM cells to STM frames and transmitting data comprising:
parallel pseudo-random binary sequence (PRBS) generation means for selectively performing a logic operation with respect to two or more PRBSs which are shifted in parallel after being generated for scrambling of the ATM cells and outputting parallel PRBSs in synchronization with an input clock after latching a result of the operation; and
data scrambling means for scrambling the parallel PRBSs generated by the parallel PRBS generation means and data to be transmitted and latching and outputting scrambled data.

2. The scrambler according to claim 1, wherein, in case of transmitting the data at an STM-1 rate of 155 Mbps, the parallel PRBS generation means comprises:
a PRBS logic unit for selecting two or more PRBSs among the parallel PRBSs which are previously generated for scrambling of the ATM cells and performing the exclusive OR operation with respect to the selected ones;
a latch unit for latching the signals from the PRBS logic unit in synchronization with an input clock and generating parallel PRBSs; and
an exclusive OR element for performing the exclusive OR operation with respect to first PRBS and second PRBS outputted from the latch unit to generate an eighth PRBS.

3. The scrambler according to claim 2, wherein the PRBS logic unit has first to seventh exclusive OR elements for selectively performing the exclusive OR operation with respect to two or more of the parallel PRBSs.

4. The scrambler according to claim 2, wherein the latch unit has first through seventh flip-flops for latching the signals from first to seventh OR elements in the PRBS logic unit in synchronization with an input clock and generating first to seventh PRBSs.

5. The scrambler according to claim 3, wherein the latch unit has first through seventh flip-flops for latching the signals from the first to seventh OR elements in the PRBS logic unit in synchronization with an input clock and generating first to seventh PRBSs.

6. The scrambler according to claim 1, wherein, in case of transmitting data at an STM-1 rate of 155 Mbps, the data scrambling means comprises:
an AND element for performing an AND operation with respect to a number of PRBSs generated by the parallel PRBS generation means and an enable signal which is generated not to scramble frame alignment bytes;
an exclusive OR element for performing an exclusive OR operation with respect to an output signal of the AND element and data to be transmitted; and
a flip-flop for latching an output signal of the exclusive OR element according to the clock and outputting scrambled data.

7. The scrambler according to claim 1, wherein, in case of transmitting data at an STM-4 rate of 622 Mbps, the parallel PRBS generation means comprises:
a PRBS logic unit for selecting two or more PRBSs among the parallel PRBSs which are previously generated for scrambling of the ATM cells and performing an exclusive OR operation with respect to the selected ones;
a latch unit for latching a number of output signals of the PRBS logic unit in synchronization with an input clock and generating parallel PRBSs; and
a logic unit for performing the exclusive OR operation with respect to two or more of output signals of the latch unit and outputting eighth to sixteenth PRBSs.

8. The scrambler according to claim 7, wherein the PRBS logic unit has first to eleventh exclusive OR elements for selectively performing the exclusive OR operation with respect to two or more of the parallel PRBSs which are generated for scrambling of the ATM cells.

9. The scrambler according to claim 7, wherein the latch unit has first through seventh flip-flops for latching the output signals of the PRBS logic unit in synchronization with the input clock and generating the parallel first to seventh PRBSs.

10. The scrambler according to claim 7, wherein the logic unit has a number of exclusive OR elements for selectively performing the exclusive OR operation with respect to the two or more output signals of first to seventh flip-flops in the latch unit and outputting the eighth to sixteenth PRBSs.

11. The scrambler according to claim 1, wherein, in case of transmitting data at an STM-4 rate of 622 Mbps, the data scrambling means comprises:
an AND element for performing an AND operation with respect to a number of PRBSs from the parallel PRBS generation means and an enable signal which is obtained not to scramble frame alignment bytes;
an exclusive OR element for performing an exclusive OR operation with respect to an output signal of the AND element and data to be transmitted; and
a flip-flop for latching an output signal of the exclusive OR element according to the clock and outputting scrambled data.
